(19) United States
(12) Patent Application Publication
(10) Pub. No.: US 2008/0214301 A1
(43) Pub. Date: Sep. 4, 2008

(54) IN-GAME ADVERTISEMENTS

(75) Inventors: Michael Sandige, Sammamish, WA (US); Gary W. Hinger, Redmond, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: WILDTANGENT, INC., Redmond, WA (US)

(21) Appl. No.: 11/948,497

(22) Filed: Nov. 30, 2007

Related U.S. Application Data
(60) Provisional application No. 60/892,690, filed on Mar. 2, 2007.

(51) Int. Cl. A63F 9/24; G06Q 30/00

(52) U.S. Cl. 463/31; 705/14

(57) ABSTRACT

Methods, apparatuses, and systems for executing an interactive executable in a production mode. The executable is configured to interact with an end user of the interactive executable. Executing the interactive executable results in a plurality of production interactive execution states of the interactive executable. A watcher module detects a sequence of one or more production interactive execution states and renders a message unassociated with the interactive executable. In embodiments, the interactive executable is a computer-implemented game, and the message is an advertisement.

### RELATED APPLICATIONS

This application claims the benefit of U.S. Provisional Application No. 60/892,690, filed on Mar. 2, 2007.

### FIELD OF THE DISCLOSURE

Embodiments of the disclosure relate to computer science, in particular to detecting a sequence of one or more states of an interactive executable executed in production mode, and upon such detection, rendering a message unrelated to the interactive executable.

### BACKGROUND OF THE DISCLOSURE

It is desirable to display advertisements to end-users during computer game playing. The well-understood method of showing or rendering advertisements during gameplay is to alter the game to include the ads. However, making changes to a computer game is expensive; it is technical, requires the cooperation or participation of the original developer of the game, and requires additional testing to make sure the game operates correctly. It is a prohibitive expense for a single game, and adapting hundreds of games is essentially not feasible.

### BRIEF DESCRIPTION OF THE DRAWINGS

Embodiments of the disclosure will be readily understood by the following detailed description in conjunction with the accompanying drawings. Embodiments of the disclosure are illustrated by way of example and not by way of limitation in the figures of the accompanying drawings.

FIG. 1 shows a method of displaying messages during execution of an interactive executable in accordance with embodiments;

FIG. 2 depicts a system configured to display during execution of an interactive executable in accordance with embodiments; and

FIG. 3 depicts a computing system suitable for practicing embodiments.

### DETAILED DESCRIPTION

In the following detailed description, reference is made to the accompanying drawings which form a part hereof, and in which are shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent. Also, embodiments may have fewer operations than described. A description of multiple discrete operations should not be construed to imply that all operations are necessary.

The description may use perspective-based descriptions such as up/down, back/front, and top/bottom. Such descriptions are merely used to facilitate the discussion and are not intended to restrict the application of embodiments of the present invention.

For the purposes of the description, a phrase in the form “A/B” means A or B. For the purposes of the description, a phrase in the form “A and/or B” means “(A), (B), or (A and B)”. For the purposes of the description, a phrase in the form “at least one of A, B, and C” means “(A), (B), (C), (A and B), (A and C), (B and C), or (A, B and C)”. For the purposes of the description, a phrase in the form “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

Embodiments of this application may display “interstitial” messages, such as advertisements, during the execution of interactive production-mode executables configured to interact with an end-user of the executable. The execution may result in a plurality of production interactive execution states and a message may be displayed upon detection, by a watcher module, of a sequence of one or more production interactive execution states. Such messages may be displayed by a watcher module using signature data related to the interactive executable. The message may be unrelated to the interactive executable.

An example of an interactive production-mode executable may be, for example, a computer-implemented game. “Production mode” may refer to, in embodiments, a mode of execution in which the interactive executable interacts with end-user(s). In embodiments where the interactive executable is a computer-implemented game, “production mode” may refer to a mode where an end-user plays the game.

In embodiments, the watcher module may cause an interruption or suspension of the interactive executable while rending and/or displaying the message. Upon completion of the display and/or rendering, the execution may resume. To be effective and to minimize disruption, the message may be rendered upon detecting a sequence of one or more production interactive execution states pre-selected because the sequence indicates an existing lull or transition in the execution of the interactive executable. For example, if the interactive executable is a computer-implemented game, the message may be displayed between game levels. Embodiments may allow messages that are unrelated to the interactive executable—such as for example advertisements—to be seamlessly displayed at selected points in the progress of the execution of the interactive executable and in a manner that may make their rendering and display appear to be part of the execution of the interactive executable. Embodiments may render and/or display a message without interrupting the execution of the interactive executable.

In embodiments, the sequence of one or more production interactive states may include one or more of a file access pattern, a memory access pattern, a memory access location, an operating system call, a call to graphics driver, a system message, an operating system message, or an elapsed time of execution.

In embodiments where the interactive executable is a computer-implemented game, the sequence of one or more production interactive states may include at least for example one or more of a game level has ended, a game level has begun, a game instance has begun, a game instance has ended, a game instance has paused, a high scores table is viewed, a game setting has been changed, a certain image is stored in video memory, and a help screen has been accessed.

Embodiments may be less expensive to implement than altering or reprogramming the computer-implemented game or interactive executable. It may be simpler, less time-consuming, and/or require less expertise to “instrument” an interactive executable (i.e. analyze the execution and resulting states) and collect “signature” data, than it would be to alter the interactive executable itself.

Embodiments may use graphical signature data. The watcher module may be configured to compare images stored in video memory with signature images. In embodiments, computed hash values of the stored images may be compared to a signature hash value. In embodiments, the watcher module may be configured to compare a fragment of the stored image to a corresponding fragment of the signature image. In embodiments, the watcher module may be configured to initially compare a small-sized fragment of the stored image to a corresponding small-sized fragment of the signature image before comparing either larger-sized fragments, full-sized images, or hash values.

Embodiments may transmit and dynamically update signature data. Embodiments may allow for maintenance and repair of signature information, and may allow for a single executable to handle the detection and display of ads for multiple games.

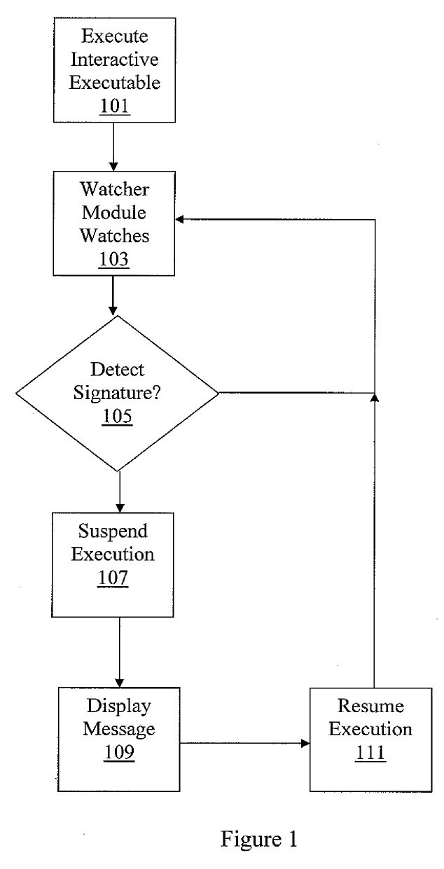

FIG. 1 shows a method of displaying messages during execution of an interactive executable in accordance with embodiments. First, an interactive executable, for example, a computer-implemented game executable, executes in a production mode 101. The interactive executable may be configured to interact with an end-user of the interactive executable in the production-mode. The executing of the interactive executable may result in a plurality of production interactive execution states of the interactive executable. Such states may include, for example, one or more of a file access pattern, a memory access pattern, a memory access location, an operating system call, a call to graphics driver, a system message, an operating system message, an elapsed time of execution, an image is stored in video memory, or other state. Embodiments are not limited to any set of production interactive execution states.

In embodiments where the interactive executable is a computer-implemented game, such states may include one or more of a game level has ended, a game level has begun, a game instance has begun, a game instance has ended, a game instance has paused, a high scores table is viewed, a game setting has been changed, a help screen has been accessed, or other computer-implemented game-specific state. Embodiments are not limited to any particular set of computer-implemented game-specific states.

A watcher module may watch for the sequence of production interactive execution states 103. In embodiments, the watcher module may be separate from the interactive executable. The watcher module may, in embodiments, monitor the interactive executable and keep track of plurality of production interactive execution states.

The watcher module may attempt to detect a sequence of one or more production interactive execution states using signature data 105. If such a sequence is not detected, it may continue to watch 103. In embodiments, the detection may include attempting to match signature data to the series of production interactive execution states as they are generated by the interactive executable. Such signature data may include, in embodiments, multiple sets of signatures, each one matching one or more production interactive execution states. In embodiments, a signature may include only a sequence of only one production interactive execution state. In other embodiments, a signature may include a sequence of multiple production interactive execution states. In such embodiments, the signature data may specify that the sequence of multiple production interactive execution states occur in a particular order.

Upon successfully detecting a signature of one or more production interactive execution states, the watcher module may suspend execution of the interactive executable 107. In alternative embodiments, such interruption may not occur, and messages may be displayed without interrupting or suspending execution of interactive executable 107. In embodiments, the watcher module may instruct an operating system to suspend active execution threads associated with the interactive executable. In embodiments, the interruption or suspension of the interactive executable may include sending the interactive executable an emulated keystroke command to pause the interactive flow of the interactive executable. In embodiments, interruption may be accomplished by hiding a window associated with the interactive executable, which may cause, depending on the interactive executable, a suspension of the interactive flow of the interactive executable. For example, if the interactive executable is a computer-implemented game, hiding the game window may cause the game to pause. In embodiments, the operation used to suspend or interrupt the interactive executable may be tailored to the interactive executable. Other methods for interrupting and/or suspecting execution may be employed. Embodiments are not limited to any particular such methods.

Upon interrupting the game, the watcher module may display a message 109. In embodiments, the message may be unrelated to the interactive executable. In embodiments, the message may be an advertisement. In embodiments, the message may be referenced by the signature data. Once the display has completed, the watcher module may cause the resumption of the interactive executable 111. At this point, in embodiments, the watcher module may resume watching states of the interactive executable.

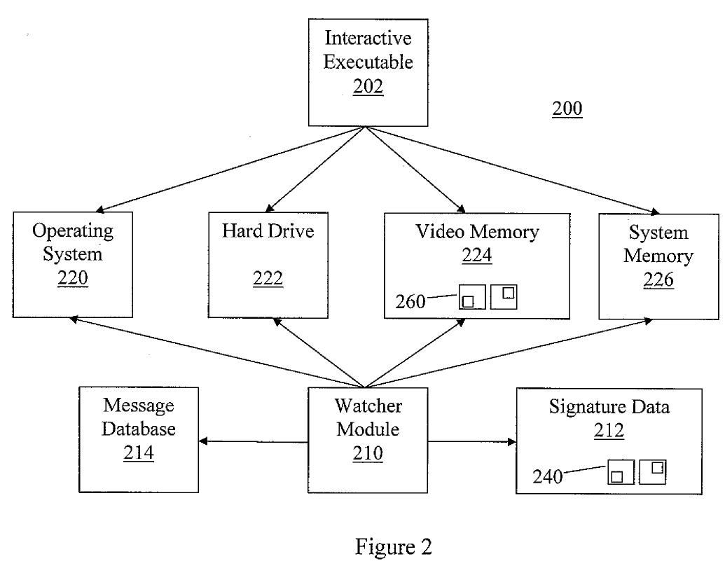

FIG. 2 depicts system 200 configured to display messages at an appropriate time during execution of interactive executable 202 in accordance with embodiments. Interactive executable 202 may be configured to execute in a production mode and interact with an end user. Such execution may result in a plurality of production interactive execution states of the interactive executable. Such states may include file accesses to hard drive 222, operating system calls to operating system 220, one or more images 240 stored in video memory 224, and other states stored in system memory 226. Though they are shown conceptually separate in FIG. 2, working copies of interactive executable 202, watcher module 210, message database 214, and signature data 212 may also be stored in system memory 226 and permanent copies may be stored on hard drive 222.

In embodiments, watcher module 210 may monitor various components of system 200 to detect a sequence of one or more production interactive execution states. In embodiments, the sequence may correspond to one of a plurality of sets of signatures stored within signature data 212. Upon detection of the sequence, watcher module may be configured to cause executable 202 to suspend and/or be interrupted and then cause a message within message database 214 to be displayed on a display (not shown).

In embodiments, a ‘signature’ may be a set of data (and/or an executable code) that may define certain specific indicators that may be monitored by the watcher module. In embodiments, the signature data 212 may be specific to interactive executable 202. Multiple signature data files may be stored within system 200. A number of potential indicators or states may be monitored, including but not limited to, display graphics 240 stored in video memory 224, file access patterns from either hard drive 222 or system memory 226, system memory 226 access patterns and locations, operating system 220 function calls, operating system messages issued by interactive executable 202, and an elapsed time of execution of interactive executable 202.

If watcher module 210 fails to identify a sequence of one or more production interactive execution states corresponding to a signature within signature data 212, watcher module 210 may do nothing. Thus, execution and user interaction, including the user's perception of the flow of interaction may be unimpaired by a missed signature.

In embodiments, a sequence of a plurality of production interactive execution states may be required to properly detect the appropriate time to display a message. In embodiments, this plurality of production interactive execution states may need to occur in a specific order and/or within specific timing intervals to match a signature.

If a particular sequence of one or more production interactive execution states occur in the proper order with the proper timing according to signature data 212, the watcher module may display a message from message database 214. In embodiments, signature data 212 may include message database 214. In other embodiments, signature data 212 may include an identifier identifying a location where the message can be retrieved. For example, signature data 212 may include a URL pointing to a server located on the Internet or other network that includes the message to be displayed. In embodiments, different messages may be associated with different signatures.

In embodiments where interactive executable 210 is a computer-implemented game, a list of non-exhaustive states may include: a new level is beginning, a level has just ended, a new game is beginning, a game has just ended, a game has been paused, a high scores table has just been viewed, a game help has been viewed, a game setting or option has been changed, and other game states. Embodiments are not limited to any particular sets of game states.

In embodiments, watcher module 210 may also be responsible for digital rights management for access to the executable.

In embodiments, signature data 212 may include graphical signatures. Graphical states may be one of the easiest types of states to detect and prepare signatures for. Graphical signatures may include signature image(s) 260 and/or a hash value corresponding to an image. Watcher module 210 may in embodiments be configured to watch for images 240 stored in video memory 224 whose hash values match a hash value of a signature. In embodiments, watcher module 210 may be configured to compare signature image(s) 260 to all or a portion of image(s) 240. In embodiments, an exact match between a signature image(s) 260 and image(s) 240 may be required to display a message. In other embodiments, inexact matches may be used to trigger display of a message. In embodiments, watcher module 210 may periodically examine video memory 224, to make a comparison to signature image(s). In embodiments, video memory 224 may be a part of system memory 226. In embodiments, no video memory may be included and system memory 226 may be used to store video data.

In embodiments, the detection of a match between signature image(s) 260 and stored image(s) 240 may be done in a series of comparisons, beginning with comparing a small-sized fragment of image(s) 240 with a small-sized fragment of signature image(s) 260 and, if the comparison yields a match, making another comparison using larger-sized fragments. Multiple iterations may be made, each one using incrementally-larger-sized-fragments. With each successive iteration, only a successful match may cause watcher module 210 to subsequently compare larger-sized fragments. In embodiments, the entire image(s) 240 may be required to match signature image(s) 260 before a message is displayed. In other embodiments, a successful image-fragment comparison may be sufficient. In embodiments, computed hash-values may be compared rather than image fragments in some or all stages of the successive-comparison process. Comparing small-sized image fragments may minimize the amount of video memory 224 accessed for most detection attempts. Accessing video memory 224 may be an ‘expensive’ operation requiring significant computing resources. Embodiments may frequently access video memory and most accesses will result in a non-match. By using a relatively small amount of video memory 224 for most comparisons, computing load may be reduced. Thus, watcher executable 210 may be less likely to affect the performance of interactive executable 202.

Several different comparison techniques may be used to compare image(s) 240 in video memory 224 to signature image(s) 260. In embodiments, an exact comparison may be required. In embodiments, hash values may be compared. In embodiments, signature images 260 and/or image(s) 240 may be resized before comparison. In embodiments, the accuracy of the comparison may be reduced by dropping least significant bits from signature data, for example. In embodiments, the comparison may take into account differing video color qualities (such as, for example, 16 bit or 32 bit). Interactive executable 202 may utilize different graphics for different monitors. In embodiments, these differences may be taken into account. A comparison technique may be chosen depending on how interactive executable 202 is configured to function. In embodiments, comparison techniques may be included in signature data 212.

Other signatures may be included in signature data 212 in various embodiments. Such signatures may include patterns of file access. In embodiments where interactive executable 202 may be a game, the game may access new files to begin a new level, for example. These accesses may be detected by watcher module 210.

In embodiments, signature data 212 may include access to system memory 226. In embodiments, certain specific system memory locations may contain detailed information about a current state of an interactive executable. These memory access patterns and memory locations may be included in signature data 212.

In embodiments, specific calls or certain patterns of calls to operating system 220 may be included in signature data 212. In embodiments, specific calls or certain patterns of calls to graphics drivers (not shown) may be included in signature data 212. In embodiments, system messages may be monitored and intercepted by watcher module 210 and scanned for information about the state of the interactive executable or game. Specific system messages may be included in signature data. As an example only, a certain call to change the color or shape of the mouse might indicate that the some event is occurring—such as for example the beginning or ending of a game.

In embodiments where interactive executable 202 is a game, the game may have specific fixed times associated with levels or puzzles; in such embodiments, time data may be included in signature data 212. Elapsed time may be used in embodiments to periodically interrupt interactive executables—for example games—that have no ideal interruption points. In embodiments, elapsed time may be used to periodically interrupt interactive executables just because it may be desirable to display messages at periodic intervals.

In embodiments, Watcher module 210 may use several features of operating system 220 to monitor interactive executable 202 for signature data, and to control interactive executable 202 in order to display messages. In embodiments, operating system 220 may be, for example, any of various Microsoft Windows operating systems. In such embodiments, watcher module 210 may replace various Windows functions using module import and export tables to intercept one or more operations of interactive executable 202. Intercepting one or more operations of interactive executable 202 may enable monitoring for signature data and/or to enable control for message display.

Functions that may be replaced in embodiments where operating system 220 is Microsoft Windows may include functions that manipulate and create threads, functions to control the display area (e.g. a “window”) of interactive executable 202, functions that pass various messages from operating system 220 to interactive executable 202, functions that track and control a pointing-device cursor, functions that control the video display devices and video memory 224 (such as for example DirectX or GDI), and functions that control the audio devices (such as for example DirectX).

In embodiments, interactive executable 202 may be configured to send predefined unique messages indicating a state of the executable. In embodiments, such messages may be sent using the Windows message queue. Watcher module 210 may be configured to monitor messages originating from the interactive executable, and, if it detects a predefined unique message, it may be configured to trigger message display based at least in part on such detection. In embodiments, the interactive executable may be configured to send such messages for the purpose of displaying messages and/or advertisements.

To display messages, the watcher module 210 may replace or cover up a window of the interactive executable 202 with a message window that may be designed to match the same graphical look of interactive executable 202. The message window then may display the message. In embodiments, interactive executable 202 may be configured to run in a full-screen mode. In such embodiments, the full screen window may be located by watcher module 210 and the message graphics may be directed into that window for rendering and/or display. In embodiments, the message may be faded in smoothly, resulting in a seamless transition to give the appearance that the message is part of the interactive executable. In embodiments, the message may be presented with translucency to display portions of the interactive executable graphics behind the message. In embodiments, audio may be played during message display. In embodiments, the message may be solely audio. In embodiments, after the message has been shown for at least some minimal period of time (determined, for example by the message itself or the signature data), a user may be able to clear the message from the display screen and/or resume the execution of interactive executable 202 (such as for example, by clicking a button or pressing a key). The message may be faded out in embodiments. Upon completion of message display, execution of interactive executable 202 may be resumed by watcher module 210.

In embodiments, signature data 212 may be decoupled from interactive executable 202 and watcher module 210. In embodiments, a large number of interactive executables may be supported by watcher module 210 and it may be advantageous to decouple signature data 212 from interactive executable 202 and watcher executable 210. Even though it may be, in embodiments, easier to prepare signature data 212 than it would be to reprogram or otherwise alter the interactive executable to include messages, signature data 212 for a large number of interactive executables; the time to prepare signatures for all interactive executables may be greater than the time required to create a single watcher module 210 executable and distribute it with interactive executable 202. Then, as updated signature data becomes available, it may be retrieved by watcher module 210. In embodiments, signature data 212 may be updated when, for example, new messages are created, refinements are made to the signatures, or when new interactive executables are needed to be supported by watcher module 210. In embodiments, watcher module 210 may check for updates when it executes

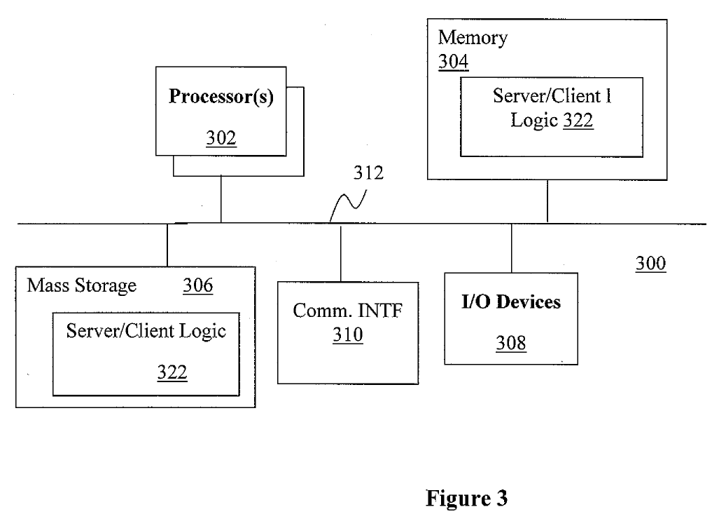

FIG. 3 illustrates an example computing system/device suitable for use to as a client device and/or server to practice various aspects of the invention. As shown, computing system/device 300 includes one or more processors 302, and system memory 304. Additionally, computing system/device 300 includes mass storage devices 306 (such as diskette, hard drive, CDROM and so forth), input/output devices 308 (such as keyboard, cursor control and so forth) and communication interfaces 310 (such as network interface cards, modems and so forth). The elements are coupled to each other via system bus 312, which represents one or more buses. In the case of multiple buses, they are bridged by one or more bus bridges (not shown).

Each of these elements performs its conventional functions known in the art. In particular, system memory 304 and mass storage 306 may be employed to store a working copy and a permanent copy of the programming instructions implementing one or more aspects of the above described teachings to practice the present invention. The programming instructions may also implement other related functions. When computing system/device 300 is being used as a server, the programming instructions may also implement accounting and other messaging-services-related functions. The programming instructions may be implemented in assembler instructions supported by processor(s) 302 or high level languages, such as C or Java, that may be compiled into such instructions, or instructions for a virtual machine (VM) operating on the processor(s), memory, and software systems of the computing system/device.

The permanent copy of the programming instructions may be placed into permanent storage 306 in the factory, or in the field, through e.g. a distribution medium (not shown) or through communication interface 310 (from a distribution server (not shown)).

Although specific embodiments have been illustrated and described for purposes of description of the preferred embodiment, it will be appreciated by those of ordinary skill in the art that a wide variety of alternate and/or equivalent implementations may be substituted for the specific embodiment shown and described without departing from the scope of the present invention. Those with skill in the art will readily appreciate that the present invention may be implemented in a very wide variety of embodiments. This application is intended to cover any adaptations or variations of the embodiments discussed herein.

What is claimed is:

1. A method comprising:
executing, by a computing device, an interactive executable in a production mode, said interactive executable configured to interact with an end user of the interactive executable, said executing resulting in a plurality of production interactive execution states of the interactive executable;
detecting, by a watcher module, a sequence of one or more production interactive execution states; and
on detection of the sequence of one or more production interactive execution states, rendering a message unassociated with the interactive executable.

2. The method of claim 1 further comprising suspending the executing by the watcher module during said rendering and seamlessly resuming the executing by the watcher module on completion of said rendering.

3. The method of claim 2 wherein the suspending includes one of: suspending one or more active execution threads of the executable, sending a pause command to the executable, or instructing the executable to hide a window of the executable.

4. The method of claim 1 wherein the message is an advertisement.

5. The method of claim 1 wherein the sequence comprises a plurality of production interactive executable states.

6. The method of claim 1 wherein the interactive executable is a computer-implemented game and the sequence of one or more production interactive states includes one or more of a game level has ended, a game level has begun, a game instance has begun, a game instance has ended, a game instance has paused, a high scores table is viewed, a game setting has been changed, and a help screen has been accessed.

7. The method of claim 1 wherein the sequence of one or more production interactive states includes one or more of a file access pattern, a memory access pattern, a memory access location, an operating system call, a call to graphics driver, a system message, an operating system message, or an elapsed time of execution.

8. The method of claim 1 wherein the sequence of one or more production interactive states includes a unique predefined message originated by the executable.

9. The method of claim 1 wherein the sequence of one or more production interactive states includes an image stored in video memory of the computing device and the detecting includes comparing the image stored in a video memory with a signature image.

10. The method of claim 9 wherein all or a portion of the image stored in video memory is an exact match of the image fragment.

11. The method of claim 9 wherein the comparing includes comparing a fragment of the signature image with a corresponding fragment of the image stored in video memory.

12. The method of claim 9 wherein the comparing further includes comparing a small-sized fragment of the signature image with a corresponding small-sized fragment of the image stored in video memory and, upon a successful match, comparing a larger-sized fragment of the signature image with a corresponding larger-sized fragment of the image stored in video memory, the larger-sized fragments larger than the small-sized fragments.

13. The method of claim 1 wherein the sequence includes an image stored in a video memory of the computing device and the detecting comprises matching a hash value of the image stored in the video memory with a signature hash value.

14. The method of claim 1 wherein the watcher module resides on a second computing device and the method further comprises sending, by the computing device, the one or more production interactive executable states to the second computing device.

15. The method of claim 1 wherein the executable comprises the watcher module.

16. An apparatus comprising:
a processor; and
a plurality of programming instructions configured to program the processor to:
execute an interactive executable in a production mode, said interactive executable configured to interact with an end user of the interactive executable, said interactive executable configured to result in a plurality of production interactive execution states of the interactive executable when executed;
detect a sequence of one or more production interactive execution states; and
upon a detection of the sequence of one or more production interactive execution states, render a message unassociated with the interactive executable.

17. The apparatus of claim 16 wherein the plurality of programming instructions are further configured to:
program the processor to suspend an execution of the interactive executable while the message is rendered; and
seamlessly resume the execution by the watcher module on completion of said rendering.

18. The apparatus of claim 16 wherein the executable is a computer-implemented game and the sequence of one or more production interactive states includes one or more of a game level has ended, a game level has begun, a game instance has begun, a game instance has ended, a game instance has paused, a high scores table is viewed, a game setting has been changed, and a help screen has been accessed.

19. The apparatus of claim 16 wherein the sequence of one or more production interactive states includes one or more of a file access pattern, a memory access pattern, a memory access location, an operating system call, a call to graphics driver, a system message, an operating system message, or an elapsed time of execution.

20. The apparatus of claim 16 further comprising a video memory and wherein the sequence of one or more production interactive states includes an image stored in the video memory and the plurality of programming instructions configured to program the processor to detect a sequence of one or more production interactive execution states further is further configured to program the apparatus to compare the image stored in a video memory with a signature image.

21. The apparatus of claim 16 further comprising a video memory and wherein the sequence includes an image stored in the video memory and the plurality of programming instructions configured to program the processor to detect a sequence of one or more production interactive execution states further is further configured to program the processor to compare a hash value of the image stored in the video memory with a signature hash value.

22. An apparatus comprising:
one or more processors;
a plurality of programming instructions configured to program the processor to:
receive, from a computing device, an interactive executable executed in a production mode on the computing device and configured to interact with an end user, a plurality of production interactive execution states of the interactive executable;
detect a sequence of one or more production interactive execution states; and
upon a detection of the sequence of one or more production interactive execution states, cause a message to be rendered on a display of the computing device, the message unassociated with the interactive executable.

23. The apparatus of claim 22 wherein the computing device further comprises video memory and wherein the sequence of one or more production interactive states includes an image stored in the video memory and the plurality of programming instructions configured to program the processor to detect a sequence of one or more production interactive execution states is further configured to program the apparatus to compare the image stored in a video memory with a signature image.

24. The apparatus of claim 22 wherein the computing device further comprises a video memory and wherein the sequence includes a hash value of an image stored in the video memory and the plurality of programming instructions configured to program the processor to detect a sequence of one or more production interactive execution states further is further configured to program the processor to compare a hash value of the image stored in the video memory with a signature hash value.

25. The apparatus of claim 22 wherein the interactive executable is a computer-implemented game and the sequence of one or more production interactive states includes one or more of a game level has ended, a game level has begun, a game instance has begun, a game instance has ended, a game instance has paused, a high scores table is viewed, a game setting has been changed, and a help screen has been accessed.
